(19) United States
(12) Patent Application Publication
(10) Pub. No.: US 2016/0088295 A1
(43) Pub. Date: Mar. 24, 2016

(54) VIDEO CODING DEVICE, VIDEO DECODING DEVICE, VIDEO SYSTEM, VIDEO CODING METHOD, VIDEO DECODING METHOD, AND COMPUTER READABLE STORAGE MEDIUM

(71) Applicant: KDDI CORPORATION, Tokyo (JP)

(72) Inventors: Tomonobu Yoshino, Fujimino-shi (JP); Sei Naito, Fujimino-shi (JP)

(21) Appl. No.: 14/959,155

(22) Filed: Dec. 4, 2015

Related U.S. Application Data
(63) Continuation of application No. PCT/JP2014/065009, filed on Jun. 5, 2014.

(30) Foreign Application Priority Data
Jun. 7, 2013 (JP) 2013-120890

(51) Int. Cl. H04N 19/117; H04N 19/182; H04N 19/172

(52) U.S. Cl. CPC H04N 19/117; H04N 19/172; H04N 19/182

(57) ABSTRACT

A video coding device that allows adaptive filtering within a coding loop and allows filter design in units of a pixel or in units of a small area that is constituted by a plurality of pixels, includes: a pixel value feature amount calculation unit configured to derive a feature amount of pixel values of a decoded image in the pixel units or the small area units; a threshold processing and sorting unit configured to compare the feature amounts derived by the pixel value feature amount calculation unit with a threshold, and to sort the respective pixels or the respective small areas based on a result of the comparison; and a dynamic threshold determination unit configured to determine the threshold based on the feature amounts derived by the pixel value feature amount calculation unit.

### CROSS-REFERENCE TO RELATED APPLICATIONS

This application is a continuation of International Patent Application No. PCT/JP2014/065009 filed on Jun. 5, 2014, and claims priority to Japanese Patent Application No. 2013-120890 filed on Jun. 7, 2013, the entire content of both of which is incorporated herein by reference.

### FIELD OF THE INVENTION

The present invention relates to a video coding device, a video decoding device, a video system, a video coding method, a video decoding method, and a computer readable storage medium.

### DESCRIPTION OF THE RELATED ART

Non-patent References 1-4 describe techniques for enhancing image quality in video compression coding by filtering coded images.

In particular, Non-patent References 1 and 2 describe video compression coding standards. These standards enable the application of filtering for reducing quality degradation that occurs at block boundaries due to compression coding.

On the other hand, Non-patent References 3 and 4 describe techniques for adaptively updating the filter that restores coding degradation on a frame-by-frame basis.

In particular, Non-patent Reference 3 describes calculating one type of filter for the entire screen, such that the square error with the original image is minimized for the entire screen. On the other hand, Non-patent Reference 4 describes designing a plurality of filters on a frame-by-frame basis, in consideration of the locality of optimal filter design.
Non-patent Reference 1: Joint Video Team (JVT) of ISO/IEC MPEG and ITU-T VCEG, “Text of ISO/IEC 14496-10 Advanced Video Coding”, July 2004.
Non-patent Reference 2: “High Efficiency Video Coding (HEVC) text specification draft 10”, JCT-VC 12th meeting, JCTVC-L1003 v34, January 2013.
Non-patent Reference 3: T. Chujoh, G. Yasuda, N. Wada and T. Yamagake, “Block-based adaptive loop filter”, ITU-T Q.6/SG16, VCEG-AI18, 2008.
Non-patent Reference 4: M. Karczewicz, P. Chen, R. Joshi, X. Wang, W. Chien, R. Panchal, “Video coding technology proposal by Qualcomm Inc.”, JCTVC-A121, April 2010.

The filtering in Non-patent Reference 1 and Non-patent Reference 2 can only be applied to quality degradation that occurs at block boundaries. The enhancement in image quality due to filtering is thus limited.

On the other hand, the filtering in Non-patent Reference 3 can be adaptively applied to the entire screen. However, with the filtering in Non-patent Reference 3, only one type of filter can be calculated for the entire screen as mentioned above.

Here, when the entire screen includes edges and flat areas partitioned by the edges, the pixels constituting the flat areas will be greater in number than the pixels constituting the edges when the screen is viewed as a whole. With one type of filter for the entire screen that is calculated in Non-patent Reference 3, the flat areas will thus be dominant compared with the edges. Accordingly, it tends to noticeable when edges lose their sharpness, and despite the edges being important patterns, with the filtering in Non-patent Reference 3, there are cases where the edge component cannot be maintained, preventing sufficient enhancement in image quality from being obtained through filtering.

Also, with the filtering in Non-patent Reference 4, a plurality of filters are designed on a frame-by-frame basis in consideration of the locality of optimal filter design, as mentioned above. Specifically, first, a feature amount based on the pixel value gradient is calculated for every predetermined small area for the pixel values of a decoded image, and the small areas are sorted by threshold processing that uses a predetermined threshold. Next, an optimal filter is designed for each set of the sorted pixels. This enables a filter for edges and a filter for flat areas to be designed separately.

However, the feature amount based on the pixel value gradient is dependent on the pattern of the image. With the threshold processing that uses the predetermined threshold mentioned above, there are thus cases where the sorting of small areas cannot be implemented optimally in filter design, thus preventing sufficient enhancement in image quality from being obtained through filtering.

### SUMMARY OF THE INVENTION

According to an aspect of the present invention, a video coding device that allows adaptive filtering within a coding loop and allows filter design in units of a pixel or in units of a small area that is constituted by a plurality of pixels, comprising: a pixel value feature amount calculation unit configured to derive a feature amount of pixel values of a decoded image in the pixel units or the small area units; a threshold processing and sorting unit configured to compare the feature amounts derived by the pixel value feature amount calculation unit with a threshold, and to sort the respective pixels or the respective small areas based on a result of the comparison; and a dynamic threshold determination unit configured to determine the threshold based on the feature amounts derived by the pixel value feature amount calculation unit.

According to this invention, the threshold that is used when sorting pixels or small areas is determined based on a feature amount derived in pixel units or small area units. The threshold can thus be determined dynamically in consideration of the pattern of the image, enabling the sorting of pixels or small areas to be optimally implemented in filter design. Accordingly, coding performance can be improved by enhancing the image quality obtained through filtering.

Further features of the present invention will become apparent from the following description of exemplary embodiments (with reference to the attached drawings).

### BRIEF DESCRIPTION OF DRAWINGS

FIG. 1 is a block diagram of a video coding device according to one embodiment of the present invention.

FIG. 2 is a block diagram of a preliminary analysis unit that is included in the video coding device according to the embodiment.

FIG. 3 is a block diagram of a video decoding device according to one embodiment of the present invention.

### DESCRIPTION OF THE EMBODIMENTS

Hereinafter, embodiments of the present invention will be described, with reference to the drawings. Note that constituent elements in the following embodiments can be replaced with existing constituent elements or the like as appropriate, and that various variations including combinations with other existing constituent elements are possible. Accordingly, the contents of the invention described in the claims are not limited by the description of the following embodiments.

Configuration and Operations of Video Coding Device AA

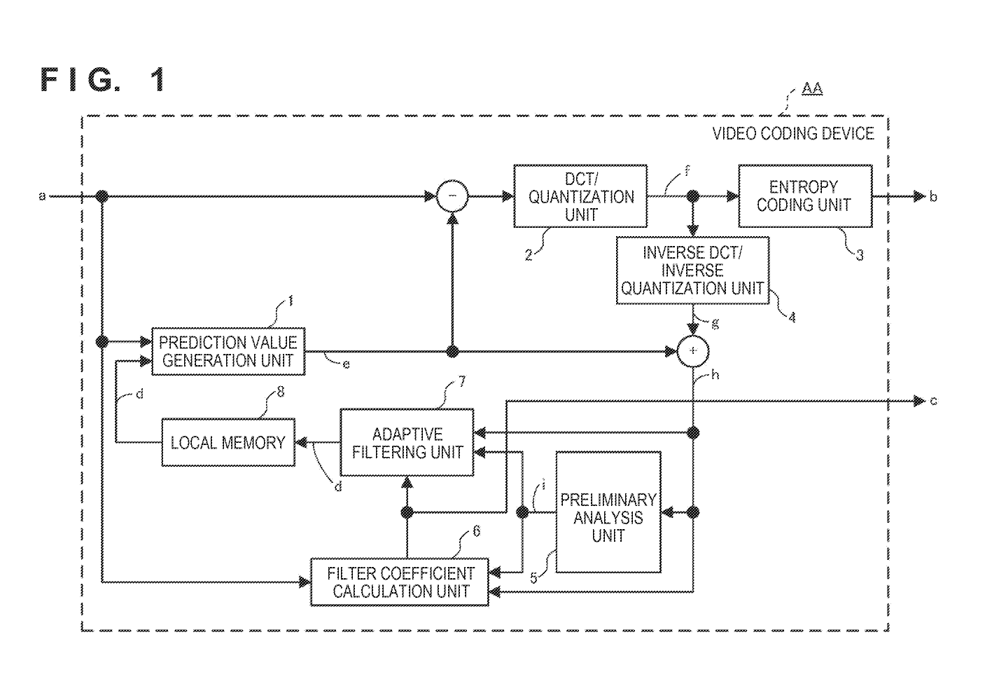

FIG. 1 is a block diagram of a video coding device AA according to one embodiment of the present invention. The video coding device AA allows adaptive filtering within a coding loop, and allows filter design in units of a pixel or in units of a small area that is constituted by a plurality of pixels. This video coding device AA is provided with a prediction value generation unit 1, a DCT/quantization unit 2, an entropy coding unit 3, an inverse DCT/inverse quantization unit 4, a preliminary analysis unit 5, a filter coefficient calculation unit 6, an adaptive filtering unit 7, and a local memory 8.

The prediction value generation unit 1 receives input of an original image a serving as an input image, and a below-mentioned filtered local decoded image d that is output from the local memory 8. This prediction value generation unit 1 generates a prediction value using a prediction method such as intra prediction or inter prediction. The prediction value generated using a prediction method with which the highest coding performance is expected is then output as a prediction value e.

The DCT/quantization unit 2 receives input of a prediction residual signal which is the difference between the original image a and the prediction value e. This DCT/quantization unit 2 orthogonally transforms the prediction residual signal, quantizes the transform coefficient obtained as a result, and outputs the quantization result as a quantized transform coefficient f.

The entropy coding unit 3 receives input of the quantized transform coefficient f. This entropy coding unit 3 entropy codes the quantized transform coefficient f, describes the result in coded data in accordance with descriptive rules (coding syntax) for describing coded data, and outputs the result as coded data b.

The inverse DCT/inverse quantization unit 4 receives input of the quantized transform coefficient f. This inverse DCT/inverse quantization unit 4 inverse quantizes the quantized transform coefficient f, inverse transforms the transform coefficient obtained as a result, and outputs the result as an inverse orthogonally transformed pixel signal g.

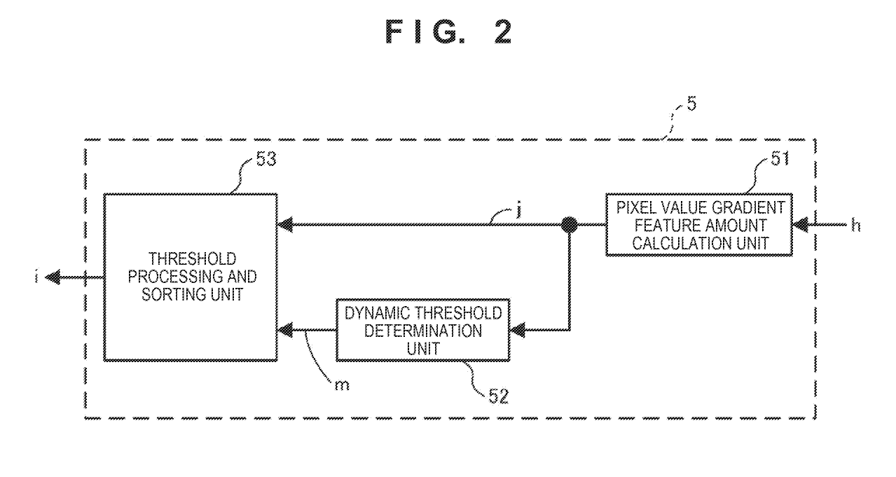

The preliminary analysis unit 5 receives input of a pre-filtering local decoded image h. The pre-filtering local decoded image h is the sum of the prediction value e and the inverse orthogonally transformed pixel signal g. This preliminary analysis unit 5 sorts pixels or small areas constituting the pre-filtering local decoded image h, and outputs the result as a sorting result i. The preliminary analysis unit 5 will be described in detail later using FIG. 2.

The filter coefficient calculation unit 6 receives input of the original image a, the pre-filtering local decoded image h, and the sorting result i. This filter coefficient calculation unit 6 calculates, for every pixel or small area that is sorted in accordance with the sorting result i, a filter coefficient that minimizes the error between the original image a and the pre-filtering local decoded image h as an optimal filter coefficient. The calculated filter coefficient is then output as coded data (filter coefficient) c.

The adaptive filtering unit 7 receives input of the coded data (filter coefficient) c, the pre-filtering local decoded image h, and the sorting result i. This adaptive filtering unit 7 performs, for every pixel or small area that is sorted in accordance with the sorting result i, filtering on the pixels of the pre-filtering local decoded image h using the filter coefficient calculated by the filter coefficient calculation unit 6. Also, the adaptive filtering unit 7 derives, for every filter control unit block, information showing the applied filter coefficient as propriety information. The filtering result and the propriety information are then output as the filtered local decoded image d.

The local memory 8 receives input of the filtered local decoded image d that is output from the adaptive filtering unit 7. This local memory 8 stores the input filtered local decoded image d, and outputs the stored image to the prediction value generation unit 1 as appropriate.

Configuration and Operations of Preliminary Analysis Unit 5

FIG. 2 is a block diagram of the preliminary analysis unit 5. The preliminary analysis unit 5 is provided with a pixel value gradient feature amount calculation unit 51, a dynamic threshold determination unit 52, and a threshold processing and sorting unit 53.

The pixel value gradient feature amount calculation unit 51 receives input of the pre-filtering local decoded image h. This pixel value gradient feature amount calculation unit 51 calculates, for every pixel or small area constituting the pre-filtering local decoded image h, a pixel value gradient, and outputs the result as a feature amount j for every pixel or small area.

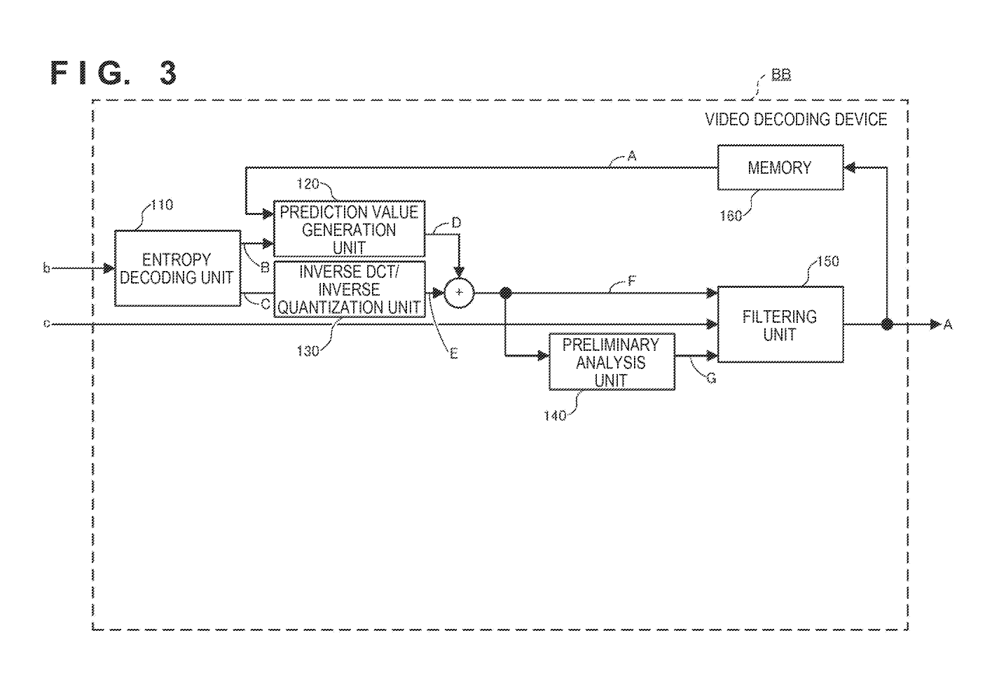

Note that it is assumed that whether the pixel value gradient is calculated for every pixel or is calculated for every small area is determined in advance. Also, in the case of calculating the pixel value gradient for every small area, it is assumed that which pixels constitute each of these small areas is determined in advance. Also, it is assumed that this predetermined information is held not only in the preliminary analysis unit 5 but also in a preliminary analysis unit 140 which will be discussed later using FIG. 3.

Also, to give an example of calculating a pixel value gradient for every small area, in the case where a pixel value gradient is calculated for every small area of N pixels×N pixels, first, the pixel value gradient of each of the N×N pixels included in this small area is derived. Next, the average value of the pixel value gradients of these pixels is calculated and taken as the pixel value gradient of this small area.

Also, a technique using a Sobel filter or a Laplacian filter, for example, can be applied to calculating the pixel value gradient.

The dynamic threshold determination unit 52 receives input of the feature amount j for every pixel or small area. This dynamic threshold determination unit 52 determines a threshold based on the feature amount j for every pixel or small area, and outputs the result as a dynamic threshold m. Specifically, first, the feature amount j for every pixel or small area is quantized with a step width Q, and a histogram is derived in relation to the values of the quantized feature amounts. Next, bins in which frequencies are concentrated are detected from among the bins of the derived histogram. Next, the frequencies of two bins that are adjacent to each other among the detected bins are derived, and a value between the two derived frequencies is determined as the threshold for these two bins. Thresholds are thereby dynamically determined so as to enable bins in which frequencies are concentrated to be sorted.

The case where, for example, K types of bins is obtained as a result of quantizing the feature amount j for every pixel or small area with the step width Q will now be described. In this case, when the kth (k is an arbitrary integer satisfying 0≦k≦K−1) frequency of the histogram is represented by h(k), the dynamic threshold determination unit 52 evaluates changes in the frequencies of consecutive bins of the histogram.

Specifically, a first-order differentiation evaluation value D₁ (k) of frequency change shown in the following equation (1) is derived, where h(K)=h(K−1) is defined for convenience.

Equation 1

D₁(k)=h(k+1)−h(k) (0≦k≦K−1) (1)

Next, second-order differentiation evaluation value D₂(k) of frequency change shown in the following equation (2) is derived, where h(−1)=h(0) and h(K)=h(K−1) are defined for convenience.

Equation 2

D₂(k)=−h(k−1)+2×h(k)−h(k−1) (0≦k≦K−1) (2)

Next, k that satisfies the following equation (3) is derived, and the frequency h(k) of the derived k is detected as the above-mentioned frequency (characteristic frequency) of bins in which frequencies are concentrated. Note that in equation (3), T1 and T2 are respectively predetermined values.

Equation 3

D₁(k)>T1 and D₂(k)>T2 (3)

Next, assuming that S number of the above-mentioned characteristic frequencies are detected, when these S characteristic frequencies are represented in ascending order as f(s) (s is an arbitrary integer satisfying 0≦s≦S−1), the threshold for f(s) and f(s+1) is determined from values between f(s) and f(s+1). (S−1) thresholds will thereby be determined.

The following two methods, for example, can be applied as a method of determining the above-mentioned threshold from the values between f(s) and f(s+1). Here, bins of the histogram corresponding to the frequency f(s) are represented as k1, and bins of the histogram corresponding to the frequency f(s+1) are represented as k2.

In the first method, the dynamic threshold determination unit 52 determines the average value of the frequency of k1 and the frequency of k2 as the threshold for k1 and k2.

In the second method, the dynamic threshold determination unit 52 respectively weights the frequency of k1 and the frequency of k2 with the following equations (4) and (5), and determines the sum of the results as the threshold for k1 and k2.

$$\begin{matrix}Equation 4 & \\ \frac{f ( s )}{f ( s ) + f ( s + 1 )} & ( 4 ) \\ Equation 5 & \\ \frac{f ( s + 1 )}{f ( s ) + f ( s + 1 )} & ( 5 )\end{matrix}$$

The threshold processing and sorting unit 53 receives input of the feature amount j and the dynamic threshold m for every pixel or small area. This threshold processing and sorting unit 53 performs threshold determination processing based on the dynamic threshold m for the feature amount j for every pixel or small area, and compares the feature amount j and the dynamic threshold m for every pixel or small area. These pixels or small areas are then sorted based on the comparison results, and the result of the sorting is output as the sorting result i. Pixels or small areas are thereby sorted into S sets by the (S−1) thresholds.

Configuration and Operations of Video Decoding Device BB

FIG. 3 is a block diagram of a video decoding device BB according to one embodiment of the present invention. The video decoding device BB allows adaptive filtering within a decoding loop, and allows filter application in units of a pixel or in units of a small area that is constituted by a plurality of pixels. This video decoding device BB is provided with an entropy decoding unit 110, a prediction value generation unit 120, an inverse DCT/inverse quantization unit 130, a preliminary analysis unit 140, a filtering unit 150, and a memory 160.

The entropy decoding unit 110 receives input of the coded data b. This entropy decoding unit 110 analyzes the contents described in the coded data b in accordance with the coded data structure, performs entropy decoding thereon, and outputs prediction information B and a residual signal C that are obtained as a result of the entropy decoding.

The prediction value generation unit 120 receives input of the prediction information B and a below-mentioned decoded image A that is output from the memory 160. This prediction value generation unit 120 determines a prediction method based on the prediction information B, and generates a prediction value D from the decoded image A in accordance with the determined prediction method, and outputs the generated prediction value D.

The inverse DCT/inverse quantization unit 130 receives input of the residual signal C. This inverse DCT/inverse quantization unit 130 inverse quantizes the residual signal C, inverse transforms the result thereof, and outputs the result as an inverse orthogonal transformation result E.

The preliminary analysis unit 140 receives input of a pre-filtering decoded image F. The pre-filtering decoded image F is the sum of the prediction value D and the inverse orthogonal transformation result E. This preliminary analysis unit 140, which is provided with a similar configuration to the preliminary analysis unit 5 and performs similar operations to the preliminary analysis unit 5, sorts pixels or small areas constituting the pre-filtering decoded image F and output the result as a sorting result G.

The filtering unit 150 receives input of the pre-filtering decoded image F, the coded data (filter coefficient) c, and the sorting result G. This filtering unit 150 performs, for every pixel or small area that is sorted in accordance with the sorting result G, filtering on the pixels of the pre-filtering decoded image F using the coded data (filter coefficient) c. The decoded image A obtained by the filtering is then output.

The memory 160 receives input of the decoded image A. This memory 160 stores the input decoded image A, and outputs the stored image to the prediction value generation unit 120 as appropriate.

According to the above video coding device AA and video decoding device BB, the following effects can be achieved.

The video coding device AA and the video decoding device BB each determine the threshold that is used when sorting pixels or small areas, based on the pixel value gradient for every pixel or small area. The threshold can thus be determined dynamically in consideration of the pattern of the image, enabling the sorting of pixels or small areas to be optimally implemented in filter design. Accordingly, coding performance can be improved by enhancing the image quality obtained through filtering.

Also, the video coding device AA and the video decoding device BB each derive a histogram of the pixel value gradient for every pixel or small area, detect bins in which frequencies are concentrated from among the bins of the derived histogram, and determine a value between the frequencies of two bins that are adjacent to each other among the detected bins as the threshold for these two bins. The threshold can thus be determined using a histogram of the pixel value gradient for every pixel or small area.

Also, the video coding device AA and the video decoding device BB each detect bins in which frequencies are concentrated, using first-order differentiation and second-order differentiation with respect to the frequencies of bins that are adjacent to each other, as described using the above-mentioned equations (1), (2), and (3). Changes in the frequencies of bins that are adjacent to each other can thus be detected by first-order differentiation and second-order differentiation with respect to the frequencies, enabling bins in which frequencies are concentrated to be appropriately detected.

Also, the video coding device AA and the video decoding device BB each determine the average value of the frequencies of two adjacent bins in which frequencies are concentrated or a weighted average value (see the above-mentioned equations (4) and (5)) of the frequencies of two adjacent bins in which frequencies are concentrated as the threshold for these two bins. The pixels or small areas respectively belonging to these two bins can thus be appropriately sorted using the threshold, enabling effects similar to the above-mentioned effects to be achieved.

Also, the video coding device AA and the video decoding device BB are each able to calculate the pixel value gradient for every pixel or small area using a Sobel filter or a Laplacian filter.

Also, the video coding device AA and the video decoding device BB each determine the threshold dynamically, and sort the pixels or the small areas using the determined threshold. Since the threshold dynamically determined by the video coding device AA or the result of sorting pixels or small areas in the video coding device AA does not thus need to be transmitted to the video decoding device BB, coding performance can be further improved as compared with the case where the threshold and the sorting result are transmitted to the video decoding device BB from the video coding device AA.

Note that the present invention can be realized by recording the processing of the video coding device AA or the video decoding device BB of the present invention on a non-transitory computer-readable recording medium, and causing the video coding device AA or the video decoding device BB to read and execute the program recorded on this recording medium.

Here, a nonvolatile memory such as an EPROM or a flash memory, a magnetic disk such as a hard disk, a CD-ROM, or the like, for example, can be applied as the above-mentioned recording medium. Also, reading and execution of the program recorded on this recording medium can be performed by a processor provided in the video coding device AA or the video decoding device BB.

Also, the above-mentioned program may be transmitted from the video coding device AA or the video decoding device BB that stores the program in storage device or the like to another computer system via a transmission medium or through transmission waves in a transmission medium. Here, the “transmission medium” that transmits the program is a medium having a function of transmitting information such as a network (communication network) like the Internet or a communication channel (communication line) like a telephone line.

Also, the above-mentioned program may be a program for realizing some of above-mentioned functions. Furthermore, the above-mentioned program may be a program that can realize the above-mentioned functions in combination with a program already recorded on the video coding device AA or the video decoding device BB, that is, a so-called patch file (difference program).

Although embodiments of this invention have been described in detail above with reference to the drawings, the specific configuration is not limited to these embodiments, and designs or the like that do not depart from the gist of the invention are intended to be within the scope of the invention.

For example, although, in the above-mentioned embodiments, the pixel value gradient for every pixel or small area was used as a feature amount for every pixel or small area, the invention is not limited thereto, and a dispersion value of pixel values for every pixel or small area may be used, for example.

Also, in the above-mentioned embodiments, the dynamic threshold determination unit 52 derives k that satisfies equation (3) and detects a frequency h(k) of the derived k as the above-mentioned characteristic frequency. However, the invention is not limited thereto, and a peak of the histogram may be detected, enabling the frequency of the detected peak to be detected as the characteristic frequency, with it being possible to detect the peak of the histogram using any of the following four methods.

In the first method, the dynamic threshold determination unit 52 derives k when the first-order differentiation evaluation value D₁(k) of equation (1) is zero at the point at which the sign of the first-order differentiation evaluation value D₁(k) changes from positive to negative, and detects the derived kth bin as a peak. The top of a protruding portion of the histogram can thereby be determined as a peak.

In the second method, the dynamic threshold determination unit 52 derives the second-order differentiation evaluation value D₂(k) of equation (2) that is greater than a predetermined value, and detects the kth bin at this time as a peak. A bin whose frequency has a higher tendency to increase than the predetermined value can thereby be determined as a peak.

In the third method, the dynamic threshold determination unit 52 detects a bin having a higher frequency h(k) than a predetermined value as a peak or a range including a peak.

In the fourth method, the dynamic threshold determination unit 52 detects the valleys of the histogram by any of the above-mentioned first, second or third methods, and detects the bin between adjacent valleys as a peak. In the case of detecting the valleys of the histogram by the first method, k when the first-order differentiation evaluation value D₁(k) is zero at the point the sign of first-order differentiation evaluation value D₁(k) of equation (1) changes from negative to positive is derived, and the derived kth bin is detected as a valley. Also, in the case of detecting the valleys of the histogram by the second method, the second-order differentiation evaluation value D₂(k) of equation (2) that is smaller than a predetermined value is derived, and the kth bin at this time is detected as a valley. Also, in the case of detecting the valleys of the histogram by the third method, a bin having a lower frequency h(k) than a predetermined value is detected as a valley or a range including a valley.

Also, although, according to the above-mentioned embodiments, the video coding device AA and the video decoding device BB each determine a threshold dynamically and sort pixels or small areas using the determined threshold, the present invention is not limited thereto, and the threshold dynamically determined by the video coding device AA or the result of sorting the pixels or small areas by the video coding device AA may be transmitted from the video coding device AA to the video decoding device BB. Since the video decoding device BB does not thereby need to determine a threshold and/or sort pixels or small areas, the computational load on the video decoding device BB can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A video coding device that allows adaptive filtering within a coding loop and allows filter design in units of a pixel or in units of a small area that is constituted by a plurality of pixels, comprising:
a pixel value feature amount calculation unit configured to derive a feature amount of pixel values of a decoded image in the pixel units or the small area units;
a threshold processing and sorting unit configured to compare the feature amounts derived by the pixel value feature amount calculation unit with a threshold, and to sort the respective pixels or the respective small areas based on a result of the comparison; and
a dynamic threshold determination unit configured to determine the threshold based on the feature amounts derived by the pixel value feature amount calculation unit.

2. The video coding device according to claim 1, wherein the dynamic threshold determination unit is further configured to determine the threshold based on a distribution of the feature amounts derived by the pixel value feature amount calculation unit.

3. The video coding device according to claim 1, wherein the dynamic threshold determination unit includes:
a characteristic bin detection unit configured to derive a histogram of the feature amounts derived by the pixel value feature amount calculation unit, and to detect bins in which frequencies are concentrated from among the bins of the derived histogram; and
a threshold determination unit configured to derive the frequencies of two bins that are adjacent to each other among the bins detected by the characteristic bin detection unit, and to determine a value between the two derived frequencies as the threshold for the two bins.

4. The video coding device according to claim 3, wherein the characteristic bin detection unit is further configured to detect bins in which the frequencies are concentrated, using first-order differentiation and second-order differentiation with respect to the frequencies of bins that are adjacent to each other among the bins of the histogram.

5. The video coding device according to claim 3, wherein the characteristic bin detection unit is further configured to determine an average value of the frequencies of two bins that are adjacent to each other among the bins detected by the characteristic bin detection unit or a weighted average value of the frequencies of two bins that are adjacent to each other among the bins detected by the characteristic bin detection unit as the threshold for the two bins.

6. The video coding device according to claim 1, wherein the pixel value feature amount calculation unit is further configured to derive a pixel value gradient as the feature amount.

7. The video coding device according to claim 6, wherein the pixel value feature amount calculation unit is further configured to derive the pixel value gradient using a Sobel filter or a Laplacian filter.

8. A video decoding device that allows adaptive filtering within a decoding loop and allows filter application in units of a pixel or in units of a small area that is constituted by a plurality of pixels, comprising:
a pixel value feature amount calculation unit configured to derive a feature amount of pixel values of a decoded image in the pixel units or the small area units;
a threshold processing and sorting unit configured to compare the feature amounts derived by the pixel value feature amount calculation unit with a threshold, and to sort the respective pixels or the respective small areas based on a result of the comparison; and
a dynamic threshold determination unit configured to determine the threshold based on the feature amounts derived by the pixel value feature amount calculation unit.

9. The video decoding device according to claim 8, wherein the dynamic threshold determination unit is further configured to determine the threshold based on a distribution of the feature amounts derived by the pixel value feature amount calculation unit.

10. The video decoding device according to claim 8, wherein the dynamic threshold determination unit includes:
a characteristic bin detection unit configured to derive a histogram of the feature amounts derived by the pixel value feature amount calculation unit, and to detect bins in which frequencies are concentrated from among the bins of the derived histogram; and
a threshold determination unit configured to derive the frequencies of two bins that are adjacent to each other among the bins detected by the characteristic bin detection unit, and to determine a value between the two derived frequencies as the threshold for the two bins.

11. The video decoding device according to claim 10, wherein the characteristic bin detection unit is further configured to detect bins in which the frequencies are concentrated, using first-order differentiation and second-order differentiation with respect to the frequencies of bins that are adjacent to each other among the bins of the histogram.

12. The video decoding device according to claim 10, wherein the characteristic bin detection unit is further configured to determine an average value of the frequencies of two bins that are adjacent to each other among the bins detected by the characteristic bin detection unit or a weighted average value of the frequencies of two bins that are adjacent to each other among the bins detected by the characteristic bin detection unit as the threshold for the two bins.

13. The video decoding device according to claim 8, wherein the pixel value feature amount calculation unit is further configured to derive a pixel value gradient as the feature amount.

14. The video decoding device according to claim 8, wherein the pixel value feature amount calculation unit is further configured to derive a dispersion value of pixel values as the feature amount.

15. The video decoding device according to claim 13, wherein the pixel value feature amount calculation unit is further configured to derive the pixel value gradient using a Sobel filter or a Laplacian filter.

16. A video system comprising a video coding device that allows adaptive filtering within a coding loop and allows filter design in units of a pixel or in units of a small area that is constituted by a plurality of pixels, and a video decoding device that allows adaptive filtering within a decoding loop and allows filter application in the pixel units or the small area units,
wherein the video coding device includes:
a coding-side pixel value feature amount calculation unit configured to derive a feature amount of pixel values of a decoded image in the pixel units or the small area units;
a coding-side threshold processing and sorting unit configured to compare the feature amounts derived by the coding-side pixel value feature amount calculation unit with a threshold, and to sort the respective pixels or the respective small areas based on a result of the comparison; and
a coding-side dynamic threshold determination unit configured to determine the threshold based on the feature amounts derived by the coding-side pixel value feature amount calculation unit, and
the video decoding device includes:
a decoding-side pixel value feature amount calculation unit configured to derive a feature amount of pixel values of a decoded image in the pixel units or the small area units;
a decoding-side threshold processing and sorting unit configured to compare the feature amounts derived by the decoding-side pixel value feature amount calculation unit with a threshold, and sorting the respective pixels or the respective small areas based on a result of the comparison; and
a decoding-side dynamic threshold determination unit configured to determine the threshold based on the feature amounts derived by the decoding-side pixel value feature amount calculation unit.

17. A video system comprising a video coding device that allows adaptive filtering within a coding loop and allows filter design in units of a pixel or in units of a small area that is constituted by a plurality of pixels, and a video decoding device that allows adaptive filtering within a decoding loop and allows filter application in the pixel units or the small area units,
wherein the video coding device includes:
a coding-side pixel value feature amount calculation unit configured to derive a feature amount of pixel values of a decoded image in the pixel units or the small area units;
a coding-side threshold processing and sorting unit configured to compare the feature amounts derived by the coding-side pixel value feature amount calculation unit with a threshold, and to sort the respective pixels or the respective small areas based on a result of the comparison;
a coding-side dynamic threshold determination unit configured to determine the threshold based on the feature amounts derived by the coding-side pixel value feature amount calculation unit; and
a transmission unit configured to transmit a result of the sorting by the coding-side threshold processing and sorting unit or the threshold determined by the coding-side dynamic threshold determination unit to the video decoding device, and
the video decoding device includes:
a reception unit configured to receive the sorting result or the threshold transmitted from the transmission unit.

18. A video coding method of a video coding device that allows adaptive filtering within a coding loop and allows filter design in units of a pixel or in units of a small area that is constituted by a plurality of pixels, the method comprising:
deriving a feature amount of pixel values of a decoded image in the pixel units or the small area units;
comparing the feature amounts with a threshold, and sorting the respective pixels or the respective small areas based on a result of the comparison; and
determining the threshold based on the feature amounts.

19. A video decoding method of a video decoding device that allows adaptive filtering within a decoding loop and allows filter application in units of a pixel or in units of a small area that is constituted by a plurality of pixels, the method comprising:
deriving a feature amount of pixel values of a decoded image in the pixel units or the small area units;
comparing the feature amounts with a threshold, and sorting the respective pixels or the respective small areas based on a result of the comparison; and
determining the threshold based on the feature amounts.

20. A non-transitory computer readable storage medium including program for causing a computer to execute a video coding method that allows adaptive filtering within a coding loop and allows filter design in units of a pixel or in units of a small area that is constituted by a plurality of pixels, the program causing the computer to execute:
deriving a feature amount of pixel values of a decoded image in the pixel units or the small area units;
comparing the feature amounts with a threshold, and sorting the respective pixels or the respective small areas based on a result of the comparison; and
determining the threshold based on the feature amounts.

21. A non-transitory computer readable storage medium including program for causing a computer to execute a video decoding method that allows adaptive filtering within a decoding loop and allows filter application in units of a pixel or in units of a small area that is constituted by a plurality of pixels, the program causing the computer to execute:
deriving a feature amount of pixel values of a decoded image in the pixel units or the small area units;
comparing the feature amounts with a threshold, and sorting the respective pixels or the respective small areas based on a result of the comparison; and
determining the threshold based on the feature amounts.
